(19) United States
(12) Patent Application Publication
(10) Pub. No.: US 2013/0212133 A1
(43) Pub. Date: Aug. 15, 2013

(54) VIRTUALISED SYSTEMS

(71) Applicants: Richard POINTON, Stoke-on-Trent (GB); Richard James Somerfield, Cheshire (GB)

(72) Inventors: Richard POINTON, Stoke-on-Trent (GB); Richard James Somerfield, Cheshire (GB)

(73) Assignee: AppSense Limited, Warrington (GB)

(21) Appl. No.: 13/587,616

(22) Filed: Aug. 16, 2012

(30) Foreign Application Priority Data
Aug. 17, 2011 (GB) 1114118.1

(51) Int. Cl. G06F 17/30

(52) U.S. Cl. CPC G06F 17/3007
USPC 707/822

(57) ABSTRACT

A computer system comprising a plurality of managed applications, a plurality of virtual application stores for storing data for respective managed applications, a metadata store and a composer engine configured to receive entity write requests from a managed application and to store metadata to identify the application store of the most recently updated application store for the entity, to receive entity read requests from another managed application and to look up in the metadata store the application store most recently updated for the requested entity and to return the entity from the application store; whereby the composer engine is configured to consolidate multiple virtual stores into a single composite virtual store.

### CROSS REFERENCE TO RELATED APPLICATION

This application claims priority to and the benefit of GB Application No. 1114118.1, filed Aug. 17, 2011, the disclosure of which is hereby incorporated by reference in its entirety.

### FIELD OF THE INVENTION

The present invention relates to computer systems and to methods of operating the same.

### BACKGROUND OF THE INVENTION

It is becoming more prevalent for computer systems to make use of virtual environments. Virtualisation is a method of redirecting an application's file and registry resource access to a store while appearing to be in the original location that the application requested the resource from. However, this can also lead to some complications. One such complication comes from the feature that a virtual system can use a virtual store per application or group of applications and each virtual store is isolated and only visible from that application or group of applications. To allow applications to share virtual store resources such as registry keys requires complex and time consuming configuration to group applications together.

### SUMMARY OF THE INVENTION

According to the present invention in a first aspect, there is provided a computer system comprising a plurality of application stores, a metadata store and a composer engine configured to receive entity write requests from a managed application and to store metadata to identify the application store of the most recently updated application store for the entity, to receive entity read requests from a managed application and to look up in the metadata store the application store most recently updated for the requested entity and to return the entity from the application store.

Suitably, the composer engine records the date and time of an entity write instruction and when a read request is received finds the application store with the most recently updated version of the entity by finding the most recent date and time entry.

Suitably, when a composer engine session is started the composer engine is configured to load a file of saved data comprising meta-data for determining most recently written to application stores for written to entities.

Suitably, when a composer engine session is closed, the composer engine is configured to save a file of data comprising meta-data for determining most recently written to application stores for written to entities.

Suitably, a last update of an application store is determined by determining when an entities' meta-data was last changed and selecting the most recently changed application store associated with the entity.

According to the present invention in a second aspect, there is provided a method of operating a computer system comprising a plurality of application stores, a metadata store and a composer engine, wherein the composer engine receives entity write requests from a managed application and stores metadata to identify the application store of the most recently updated application store for the entity, receives entity read requests from a managed application and looks up in the metadata store the application most recently updated for the requested entity and returns the entity from the application store.

According to the present invention in a third aspect there is provided a computer program for operating a method according to the second aspect of the present invention.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a schematic illustration of a system according to the present invention.

FIG. 2 is a functional flow diagram illustrating a method of operating a computer system according to the present invention showing a write operation.

FIG. 3 is a functional flow diagram illustrating a method of operating a computer system according to the present invention showing a read operation.

FIG. 4 illustrates a example of a section of a meta-data XML file for use with this embodiment of the present invention.

### DESCRIPTION OF THE PREFERRED EMBODIMENTS

The aspects and features of the present invention are described hereinafter with reference to flowchart illustrations of user interfaces, methods, and computer program products according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

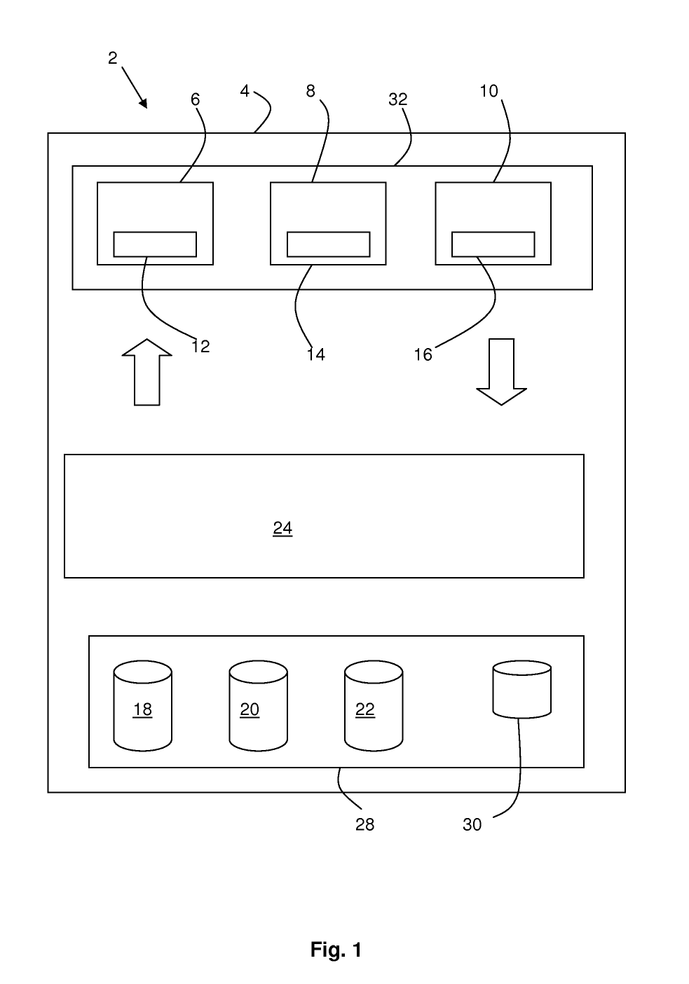

Referring to FIG. 1 of the accompanying drawings, there is shown a computer system 2 according to an embodiment of the present invention comprising a local computer 4 running a first application 6, a second application 8 and a third application 10. The first application 6 has a first in-process virtualiser 12. The second application 8 has a second in-process virtualiser 14. The third application 10 has a third in-process virtualiser 16. The first application 6 has a first virtual application store 18. The second application 8 has a second virtual application store 20. The third application 10 has a third virtual application store 22. The application store is comprised of meta-data, and data, where the data consists of file and registry system entities that are stored in a hierarchical structure. Between the application stores 18-22 and the applications 6-10 is a composer engine 24. The in-process virtualisers 12-16, the composer 24 and the application stores 18-22 are on the local computer 4. Alternatively, the composer 24 and the application stores 18-22 can be on a virtual server (computer system). The application stores 18-22 are held in the native file system and/or registry. A memory 28 stores a meta-data store 30. The applications run in an operating system session indicated schematically at 32.

The applications 6-10 can be different or multiple instances of the same application.

Architecturally, the composer 24 is a layer between a managed application 6-10, and the application's virtual store 18-22, respectively. Interactions (file and registry I/O) through the in-process virtualiser 12-16 to the individual application's store 18-22 are read-write, interactions with other application's stores 18-22 are read only.

For each application 6-10, the in-process virtualiser 12-16 is a module that is injected at runtime into a user mode process to facilitate virtualisation of an application and therefore make it a manageable application. A managed application 6-10 then is an application whose file and registry data is virtualised.

The composer engine 24 is a multi-store composition engine that uses a SQL database engine to compose meta-data from multiple stores into a single composite view.

A managed application 6-10 reads and writes from its own virtual store 18-22 but can only read from other applications' stores 18-22, with the composer 24 providing an ID for the virtual store that contains the newest version of a requested entity. If a managed applications 6-10 in-process virtualiser 12-16 needs to write to a shared entity if must perform a copy on write function for the data to get copied into its virtual store and update the meta-data for its store so that in the composed view the applications store is now the newest. The composer 24 consolidates information across disparate stores. The composition layer sits between the applications and the individual virtual application stores so that every relevant managed application can see the latest files folders/registry and any other data to ‘compose’, even if the latest is from a different application's virtualised application store. It is also possible to control the granularity of the composer so that there is control over which applications get to compose from which other application's virtualised application stores. It may be for just a single application (but every process instance) or it may be per-process instance (so that, e.g. two different WORD (trade mark) processes see different composed stores).

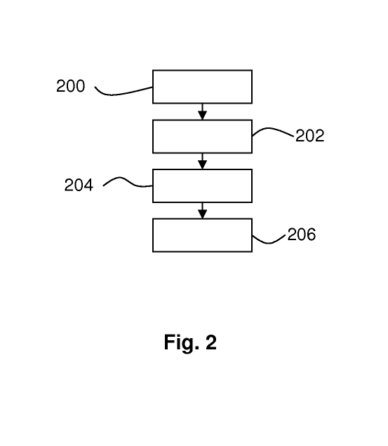

Referring to FIG. 2 of the accompanying drawings there is shown a method of operating a computer system in a write operation.

At step 200, the first application 6 writes a registry key to the first virtual application store 18.

At step 202, the write instruction is intercepted by the in-process virtualiser 12.

At step 204, the in-process virtualiser 12 sends the write instruction to the first virtual application store 18.

At step 206, the write instruction is intercepted by the composer engine 24 which updates the meta-data store 30 for the registration key entity that is being written. The composer engine 24 does not interfere with the write operation.

For each entity, the composer 24 maintains the meta-data fields “Name”, “ParentID”, “Type”, “StoreID” “Attributes” and “ComposerModTime”.

“Name” is the name of the entity.

“ParentID” is is the ID of a parent container the entity is part of. These IDs permit a directory structure to be used.

“Type”—an entity can be one of two types: item or container..

“StoreID” is a globally unique identifier (GUID) for the store of the entity.

“Attributes” is the attributes of the entity. This is a piece of opaque data as far as the composer is concerned and is driven by the high level application that uses the composer, in this case the in-process virtualiser 12.

“ComposerModTime” is the date and time when the entities' meta-data last changed. Actual file modification times may be stored in the attributes field.

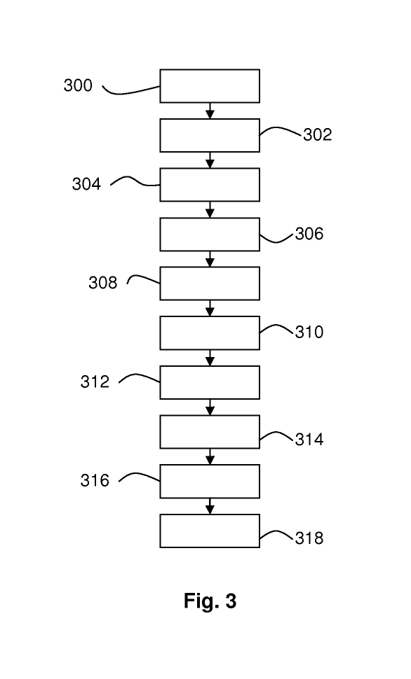

Referring to FIG. 3 of the accompanying drawings there is shown a method of operating a computer system in a read operation.

At step 300 pre-existing meta-data from a previous session is loaded. This is explained in more detail below after operation of the composer engine 24 has been further described.

At step 302 a WINDOWS (trade mark) session 32 registers with the composer engine 24 with each application or group of applications 6-10 registering with the composer engine 24. The composer engines are hosted per WINDOWS session.

At step 304 the second application 8 requests file or registry information by use of a file or registry path e.g. \device\harddiskvolume2\applicationdata\Microsoft\Word\English.dic.

At step 306, the request is intercepted by the in-process virtualiser 14 for that application 8.

At step 308, the in-process virtualiser 14 requests the location of the file or registry information from the composer engine 24. The in-process virtualiser 14 identifies the entity it wants to obtain by the following meta-data fields: “Name”, “Type”, “ParentID” and “StoreID”.

At step 310, the composer engine 24 looks up the location of the requested file or registry information in the meta-data store 30.

The composer engine 24 determines the most recently updated location for that entity from the ComposerModTime field and looks up the StoreID for that location.

All of the meta-data from all the virtual stores are contained in one SQL table, where the virtual store ID of the meta-data item is contained within the database row.

Pseudo code for the SQL select to extract meta-data for the composite view is as follows:
SELECT entity data items FROM Meta-data table
   SELF JOIN
SELECT the key fields of newest item across all stores FROM Meta-data table

For example querying the meta-data table for particular entity that exists in two virtual stores would give the results in the figure below. When the query for the composed view is run then the entity with store ID beginning with 689B946 would be returned as it has the newest composer modification time.

| Name | ParentID | Type | StoreID | Attributes | ComposerModTime |
|---|---|---|---|---|---|
| Test | 17 | Container | C0232F1F- | AAAAAAISAEMAcg | 2011-01-21 |
| shared | | | 577F-4A72- | BIAGEAd | 14:42:46.789 |
| | | | 9561-6 | | |
| Test | 17 | Container | 689B9646- | AAAAAAISAEMAcg | 2011-01-21 |
| shared | | | 1D7E- | BIAGEAd | 14:42:47.117 |
| | | | 4ECS- | | |
| | | | 8984-D | | |

A role of the composer engine 24 is to tell the in-process virtualiser requestor which store 18-22 contains the newest instance of the requested piece of information, so that the in-process virtualiser 12-16 can redirect an application's request for a resource to a virtual store. The location of the virtual store is saved when an application is registered with the composer. As part of the registration a storeID key field for the virtual store (in the form of a GUID) is saved and a store ID is associated with each entity in the database when it is created. When the composer returns an entity for a request the in-process virtualiser can then request the location of the virtual store for the entity and use this to redirect the managed application to the correct virtual store location.

At step 312, the composer engine 24 provides the location of the requested file or registry information to the in-process virtualiser 14.

At step 314, the in-process virtualiser 14 fetches the requested file or registry information from the application store it has been given by the composer engine 24.

At step 316, the in-process virtualiser 14 provides the requested file or registry information to the application 8 that initiated the request.

At step 318 the composer engine 24 is shut down, usually as a result of the WINDOWS session with which it is associated being ended, and saves meta-data to the meta-data store. Of course, many information requests may be processed before the composer engine 24 is shut down.

The use of an in-memory database means that when an instance of a composer engine is released the meta-data will not be persisted. To facilitate persistence of meta-data an XML import/export feature is provided that allows the meta-data to be imported when a composer engine is started and exported at release. This facility also provides for the fact that a virtual store may not be present on the local machine and therefore the meta-data for the store can be loaded into the database without needing to copy the whole of the virtual store to the local machine.

The XML meta-data is used to capture structure of the entities as well as key fields of the entities such as name, parent etc. The collection of attributes that are not key fields such as size, creation date or any in-process virtualiser extension attributes are also persisted in the meta-data in an opaque attributes field. The elements within the XML can be of two types, containers or items. Containers can be used to represent directories or registry keys and items to represent files or registry key values. Containers can have child containers or child items and this mechanism is used to store the hierarchical structure of the file and registry systems in a virtual store. To allow files and registry key meta-data to exist within the same file the Windows kernel object manager namespace format is used e.g. typically\device\hardiskvolume2 represents the root of a Windows file system volume such as C:\ and \registry\machine represents HKEY_LOCAL_MACHINE the root of the Windows machine registry hive.

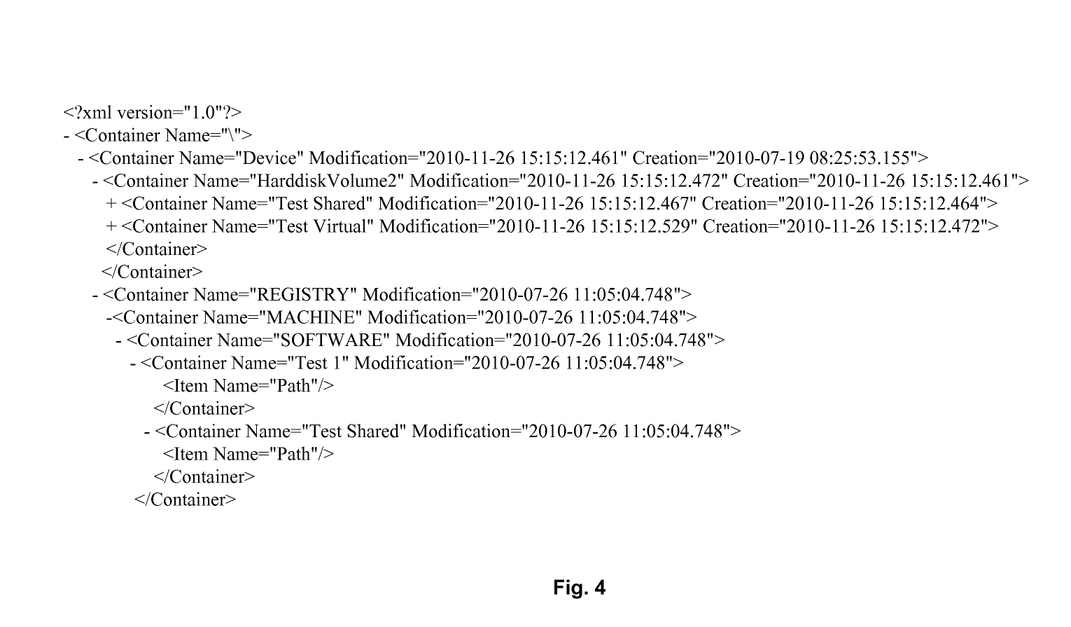

An example of a section of a meta-data XML file is shown in FIG. 4 of the accompanying drawings.

Although shown in FIG. 1 as a plurality if managed (virtualised) applications running on a local computer, the applications can operate on the local computer with the composer and/or virtual application stores being on a remote device, usually a device configured as a server.

The present invention extends to computer programs configured to operate methods according to the present invention, carriers and downloads therefor.

Embodiments of the present invention support multiple composer engine instances. Generally, this is a single instance per-session, but to enable isolated composer instances more instances of a composer engine are permitted within the current Windows session. When an application is registered with the composer it passes a database ID to the composer. This enables the composer to associate a managed application's store with a set off tables in the SQL database. Shared applications can be registered with the same database ID while isolated applications can be registered with a unique database ID. This database schema is used by the composer engines as single instance of an in-memory SQL database is used to provide the best query performance.

The composer engine is designed to provide the ability to have many per-application stores, whilst being able to keep the in-process virtualiser simple. Therefore, the role of the composer engine is to consolidate multiple virtual views, in to a single composite virtual view. The composition algorithm is based on the idea that within the composed virtual view, the combination of Item Name & Item Type & Parent Container and Store ID is unique and therefore forms a primary key of all meta-data rows. All of the meta-data beyond the key fields described for each entity within a virtual store are stored within an opaque (to the composer) attribute field. The last modification of an entities meta-data is stored in a composer modification time field. When a managed application requests data from the composer, it is automatically consolidated based on the newest entity from all stores as determined by the composer modification time.

Accordingly, the in-process virtualiser does not need to iterate through all virtual stores to find the most relevant data item.

Embodiments of the present invention are particularly suitable, but not exclusively so, for use with the AppSense Environment Manager (trade mark) which virtualises applications.

The composer engine allows multiple virtual stores to be shared as read only across multiple applications while allowing each individual application to maintain its read/write access to file and registry resources in a virtual store. The solution makes isolated managed application virtual stores the exception rather than the norm.

The composer engine is extendible and supports the association of opaque data in the form of a collection of attributes with entities in the meta-data. This allows the in-process virtualiser to store specific data for its needs, e.g. a visibility flag may be stored that indicates if an entity is to appear to be deleted when returning results to a managed application. Similarly actual modification and size data may be stored in attributes for an entity without this affecting the schema of the database that the composer uses to store the meta-data.

Although the preferred embodiments of the present invention have been described with reference to the WINDOWS operating system, it will be appreciated that the principles of the invention can extend to other operating systems.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer system comprising a plurality of managed applications, a plurality of virtual application stores configured for storing data for respective managed applications, a metadata store and a composer engine configured to receive entity write requests from a managed application and to store metadata to identify the application store of the most recently updated application store for the entity, to receive entity read requests from another managed application and to look up in the metadata store the application store most recently updated for the requested entity and to return the entity from the application store; whereby the composer engine is configured to consolidate multiple virtual stores into a single composite virtual store.

2. The computer system of claim 1, wherein the composer engine records the date and time of an entity write instruction and when a read request is received finds the application store with the most recently updated version of the entity by finding the most recent date and time entry.

3. The computer system of claim 1, wherein when a composer engine session is started the composer engine is configured to load a file of saved data comprising meta-data for determining most recently written to application stores for written to entities.

4. The computer system of claim 1, wherein when a composer engine session is closed, the composer engine is configured to save a file of data comprising meta-data for determining most recently written to application stores for written to entities.

5. The computer system of claim 1, wherein a last update of an application store is determined by determining when an entities' meta-data was last changed and selecting the most recently changed application store associated with the entity.

6. A method of operating a computer system comprising a plurality of managed applications, a plurality of virtual application stores for storing data for respective managed applications, a metadata store and a composer engine, wherein the composer engine receives entity write requests from a managed application and stores metadata to identify the application store of the most recently updated application store for the entity, receives entity read requests from another managed application and looks up in the metadata store the application most recently updated for the requested entity and returns the entity from the application store; whereby the composer engine is configured to consolidate multiple virtual stores into a single composite virtual store.

7. A computer program for operating a method according to claim 6.
